(19) United States
(12) Patent Application Publication
(10) Pub. No.: US 2026/0126107 A1
(43) Pub. Date: May 7, 2026

(54) RACK AND PINION DRIVE APPARATUS

(71) Applicant: FALCON AUTOTECH PRIVATE LIMITED, Delhi (IN)

(72) Inventors: Dheeraj VERMA, Noida (IN); Sonu YADAV, Noida (IN); Ravi RAVI, Gurugram (IN); Shanky Kumar MANGLA, Faridabad (IN)

(21) Appl. No.: 18/857,842

(22) PCT Filed: May 25, 2023
(86) PCT No.: PCT/IN2023/050500

§ 371 Date: Oct. 18, 2024

(51) Int. Cl. F16H 55/26; B65G 1/06; F16H 19/04; F16H 55/08

(52) U.S. Cl. CPC F16H 55/26; B65G 1/065; F16H 19/04; F16H 2055/0866

(57) ABSTRACT

Disclosed is a rack and pinion drive apparatus (100). The rack and pinion drive apparatus (100) includes a pinion (102) provided with a number of pinion teeth (108) such that each pinion teeth of the plurality of pinion teeth (108) comprises a top land (202) and a bottom land (204). A rack (104) provided with a number of rack teeth (106) such that a set of rack teeth of the plurality of rack teeth (106) includes a rack chamfered edge (112). The top land (202) of each pinion teeth of the number of teeth (108) includes a pinion chamfered edge (202A) such that the pinion chamfered edge (202A) is configured to engage with the rack chamfered edge (112) of the set of rack teeth of the number of rack teeth (106) to facilitate meshing of the plurality of pinion teeth (108) with the number of rack teeth (106).

### TECHNICAL FIELD

The present disclosure relates to rack and pinion. More particularly, the present disclosure relates to a rack and pinion drive apparatus.

### BACKGROUND

Rack and pinion arrangement is an important transmission mode in field of mechanical transmission, and has a wide range of applications in the fields of mechanical equipment, stairlifts, actuators and so on. The rack and pinion arrangement are widely used transmission mechanism for converting rotary motion into linear motion and vice versa.

The meshing of rack and pinion teeth is not a problem unless the pinion is allowed to move up to the length of rack. There are certain situations such as pinion is moved more than the length of rack and then re-engaged there are chances of improper meshing of top surface of rack and pinion teeth due to which a deadlock is created or the pinion may run over the rack and engages with sudden jerk. The reason of this sudden jerk is that when the top surface of engaging teeth of pinion comes within contact of engaging teeth of rack a reaction force is generated at contact point which is normal to the top surface of pinion teeth. Since the normal to the top surface of pinion teeth is always directed towards the pinion centre, this force will not rotate pinion to engage properly. This problem can be solved by increasing the number of teeth on pinion or by making the initial few teeth of rack in increasing order in terms of their size. This necessitates the length of the rack to increase beyond the desired length of the rack, which may not be a suitable approach while using the rack and pinion arrangement.

In view of the above stated problem, there remains a need for the requirement of a rack and pinion drive apparatus that is able to overcome the issue of deadlock (sudden jerk) and increased length of the rack and pinion arrangement.

### SUMMARY

In view of the foregoing, a rack and pinion drive apparatus has been provided. The rack and pinion drive apparatus includes a pinion having a plurality of pinion teeth in a manner that each pinion teeth of the plurality of pinion teeth comprises a top land and a bottom land. A rack having a plurality of rack teeth in a manner that a set of rack teeth of the plurality of rack teeth comprises a rack chamfered edge. The top land of each pinion teeth of the plurality of pinion teeth comprises a pinion chamfered edge in a manner that the pinion chamfered edge is configured to engage with the rack chamfered edge of the set of rack teeth of the plurality of rack teeth to facilitate meshing of the plurality of pinion teeth with the plurality of rack teeth. A chamfer angle of the pinion chamfered edge of the top land of the pinion tooth lies between from about 5 degrees (5°) to about 45 degrees (45°). The height of the plurality of pinion teeth lies between from about 6 millimetre (6 mm) to about 8 mm. The pinion chamfered edge of the top land of the pinion tooth is configured to shift the direction of reaction force from the radial direction of the pinion such that the degree of shift of the direction of the reaction force lie between from 35° to about 45° from the radial direction of the pinion. The width of the plurality of pinion teeth (108) lies between from about 4.5 mm to about 5 mm.

In an aspect, a storage facility of warehouse includes a robot having a robot wheel that is operatively coupled to a pinion that is configured to rotate on the rack. The pinion having a plurality of pinion teeth in a manner that each pinion teeth of the plurality of pinion teeth comprises a top land and a bottom land. A plurality of shelf having a rack and the rack having a plurality of rack teeth in a manner that a set of rack teeth of the plurality of rack teeth comprising a rack chamfered edge. The top land of each pinion teeth of the plurality of pinion teeth comprises a pinion chamfered edge in a manner such that the pinion chamfered edge is configured to engage with the rack chamfered edge of the set of rack teeth of the plurality of rack teeth to facilitate meshing of the plurality of pinion teeth with the plurality of rack teeth. The pinion chamfered edge of the top land of the pinion tooth is configured to shift the direction of reaction force from the radial direction of the pinion such that the degree of shift of the direction of the reaction force lie between from 35° to about 45° from the radial direction of the pinion.

In an aspect, a method for meshing a pinion with a rack has been provided. The method includes steps of chamfering a pinion chamfered edge of a top land of each pinion teeth of a plurality of pinion teeth; the chamfering a rack chamfered edge of a set of rack teeth of a plurality of rack teeth; meshing the plurality of the pinion teeth with the plurality of rack teeth by engaging the chamfered edge of the top land of each pinion teeth of the plurality of teeth with the rack chamfered edge of the set of rack teeth of the plurality of rack teeth. The method further includes shifting the direction of reaction force from the radial direction of the pinion such that the degree of shift of the direction of the reaction force lie between from 35° to about 45° from the radial direction of the pinion. The pinion is configured to mesh with the rack from either of a first end or a second end of the rack such that the pinion rolls in direction perpendicular to the axis of rotation of the pinion, and parallel to the pitch line of rack teeth while meshing with the rack.

### BRIEF DESCRIPTION OF DRAWINGS

The above and still further features and advantages of embodiments of the present invention becomes apparent upon consideration of the following detailed description of embodiments thereof, especially when taken in conjunction with the accompanying drawings, and wherein:

FIG. 1 illustrates a front view of a rack and pinion drive apparatus, according to an embodiment herein;

FIG. 2A illustrates a front view of a pinion, according to another embodiment herein;

FIG. 2B illustrates a front view of a tooth of a plurality of teeth of the pinion, according to another embodiment herein;

FIG. 3 illustrates a front view of a rack, according to another embodiment herein;

FIG. 4a illustrates a front view of a storage facility, according to another embodiment herein;

FIG. 4b illustrates a front view of a rack and pinion drive apparatus in storage facility, according to another embodiment herein;

FIG. 4c illustrates an isometric view of a rack and pinion drive apparatus in storage facility, according to another embodiment herein; and

FIG. 5 illustrates a flowchart for the method of meshing a pinion with a rack.

To facilitate understanding, like reference numerals have been used, where possible, to designate like elements common to the figures.

### DETAILED DESCRIPTION OF THE DRAWINGS

Various embodiment of the present invention provides a rack and pinion drive apparatus. The following description provides specific details of certain embodiments of the invention illustrated in the drawings to provide a thorough understanding of those embodiments. It should be recognized, however, that the present invention can be reflected in additional embodiments and the invention may be practiced without some of the details in the following description.

The various embodiments including the example embodiments are now described more fully with reference to the accompanying drawings, in which the various embodiments of the invention are shown. The invention may, however, be embodied in different forms and should not be construed as limited to the embodiments set forth herein. Rather, these embodiments are provided so that this disclosure is thorough and complete, and fully conveys the scope of the invention to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “top,” “bottom,” and the like, may be used herein for ease of description to describe one element or feature's relationship to another element(s) or feature(s) as illustrated in the figures. It is to be understood that the spatially relative terms are intended to encompass different orientations of the structure in use or operation in addition to the orientation depicted in the figures.

Embodiments described herein refer to plan views and/or cross-sectional views by way of ideal schematic views. Accordingly, the views may be modified depending on simplistic assembling or manufacturing technologies and/or tolerances. Therefore, example embodiments are not limited to those shown in the views but include modifications in configurations formed on basis of assembling process. Therefore, regions exemplified in the figures have schematic properties and shapes of regions shown in the figures exemplify specific shapes or regions of elements, and do not limit the various embodiments including the example embodiments.

The subject matter of example embodiments, as disclosed herein, is described with specificity to meet statutory requirements. However, the description itself is not intended to limit the scope of this patent. Rather, the Applicant has contemplated that the claimed subject matter might also be embodied in other ways, to include different features or combinations of features similar to the ones described in this document, in conjunction with other technologies.

As mentioned there remains a need to provide a rack and pinion drive apparatus that is able to overcome the issue of deadlock (sudden jerk) and increased length of the rack and pinion drive apparatus.

The term “reaction force” as used herein the context of the present disclosure refers to a force value that is acting perpendicular to the surface of the component/element/device/unit, for which the terminology is being used in the present disclosure.

The term “radial direction” as used herein the context of the present disclosure refers to the direction of radius i.e., direction towards the centre of a unit/component/element/device of the present disclosure.

The symbol “mm” as used herein the description denotes the unit of distance i.e., millimetre.

The following symbols as used herein the context of the present disclosure are provided hereinbelow along-with their respective meanings:
“t”—width of tooth
“f”—Tangential force on tooth
“y”—Distance from the top surface of the tooth
“b”—Thickness of the tooth
“s”—Yield strength of the tooth material

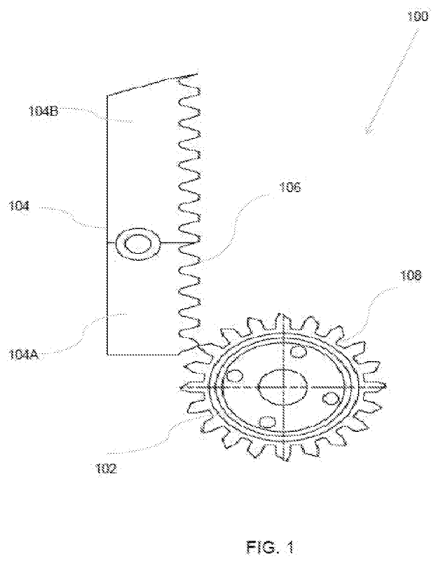

FIG. 1 illustrates a front view of rack and pinion drive apparatus (100). The rack and pinion apparatus (100) includes a pinion (102) and a rack (104). The pinion (102) includes a number of pinion teeth (108) (hereinafter referred to and designated as “the pinion tooth (108)”). The rack (104) includes a first end (104A) and a second end (104B) such that the length of the rack (104) extends from the first end (104A) to the second end (104B). The rack (104) further includes a number of rack teeth (106) (hereinafter individually referred to and designated as “the rack tooth (106)”) such that the number of rack teeth (106) are arranged from the first end (104A) to the second end (104B) of the rack (104).

The number of pinion teeth (108) of the pinion (102) may be configured to mesh with the number of rack teeth (106) of the first end (104A) of the rack (104). Upon meshing of the pinion (102) with the rack (104), the pinion (102) may be configured to roll from the first end (104A) of the rack (104) to the second end (104B) of the rack (104).

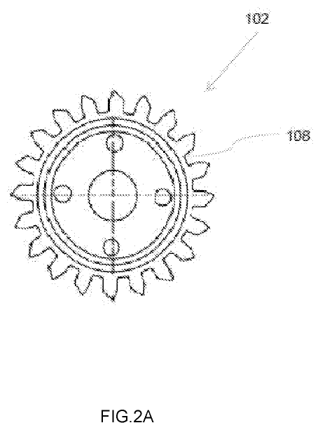

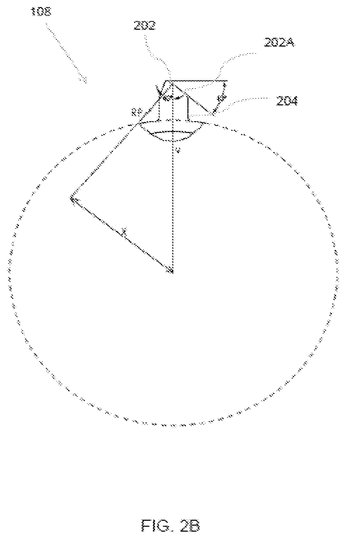

FIG. 2A illustrates a front view of a pinion (102) and FIG. 2B illustrates a front view of the pinion tooth (108). Each pinion teeth of the number of pinion teeth (108) may include a top land (202) and a bottom land (204) as can be clearly seen through FIG. 2B. The top land (202) may be the distal end of the pinion tooth (108) i.e., the end of the pinion tooth (108) that is away from a base circle of the pinion (102). The bottom land (204) may be the proximal end of the pinion tooth (108) i.e., from where the pinion tooth (108) projects outwardly from the base circle of the pinion (102). The top land (202) of the pinion tooth (108) may exhibit a pinion chamfered edge (202A). The pinion chamfered edge (202A) may be configured to shift or deviate the reaction force that is acting perpendicularly to the top land (202) of the pinion tooth (108), by some angle away from the radial direction of the pinion (102). This deviation in reaction force from the radial direction provides “R_{f}*X” moment to the pinion (102) that provides rotation to the pinion (102) at the time of meshing of the pinion (102) with the rack (104), thus preventing or eliminating jamming or improper meshing of the pinion tooth (108) of the pinion (102) with the rack tooth (106) of the first end (104A) of the rack (104). The angle of chamfer of the pinion chamfered edge (202A) of the pinion tooth (108) may be governed by minimum thickness of the top land (202) of the pinion tooth (108), for example, the angle of chamfer of the pinion chamfered edge (202A) of the top land (202) of the pinion tooth (108) is 40 degrees (40°). The minimum thickness of the top land (202) of the pinion tooth (108) is expressed as:

$$t = s * q * r * t [ \frac{6 * f * y}{( b * s )} ]$$

The above expression, for minimum thickness of the top land (202) of the pinion tooth (108), gives a parabolic curve. If the actual thickness of the top land (202) of the pinion tooth (108) is greater than the calculated thickness of the top land (202) as calculated by the above expression, then the profile of the pinion tooth (108) is safe for a specified applicable load.

In some embodiments, a chamfer angle of the pinion chamfered edge (202A) of the pinion tooth (108) may lie between from about 5 degrees (5°) to about 45 degrees (45°).

In some embodiments, the distance from the top land (202) to the bottom land (204) of the pinion tooth (108) i.e., the height of the plurality of pinion teeth (108) may lie between from about 6 milli-meter (6 mm) to about 8 mm.

In some embodiments, the width of the plurality of pinion teeth (108) may lie between from about 4.5 mm to about 5 mm.

In some embodiments, the shift or deviation in direction of the reaction force exerting on the pinion chamfered edge (202A) from the radial direction may lie between from about 35° to about 45°.

In some embodiments, the height, and the width of each tooth of the plurality of pinion teeth may depend upon the relations as given in table below:

| | 14.5° full depth | | 20° full depth | | | |
|---|---|---|---|---|---|---|
| | system | | system | | 20° stub system | |
| Pressure angle | 14.5° | | 20° | | 20° | |
| Addendum | m | | m | | 0.8 | m |
| Dedendum | 1.157 | m | 1.25 | m | m | |
| Clearance | 0.157 | m | 0.25 | m | 0.2 | m |
| Working depth | 2 | m | 2 | m | 1.6 | m |
| Whole depth | 2.157 | m | 2.25 | m | 1.8 | m |
| Tooth thickness | 1.5708 | m | 1.5708 | m | 1.5708 | m |

The symbol ‘m’ as used in table hereinabove refers to module of the pinion. The module of the pinion refers to the ratio of diameter of the pinion to number of teeth of the pinion.

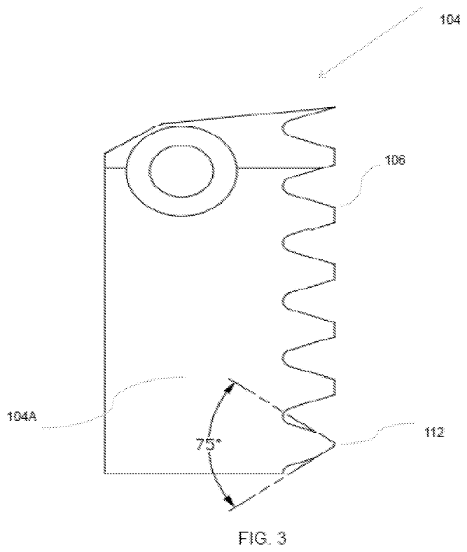

FIG. 3 illustrates a front view of a rack (104). A set of rack teeth of the number of rack teeth (106) that are arranged on the first end (104A) of the rack (104) may exhibit a rack chamfered edge (112). The rack chamfered edge (112) may be provided on the rack teeth (106) of the first end (104A) of the rack (104) such that the set of rack teeth (106) of the first end (104A) may be pointed.

In operation, the pinion (102) may be configured to mesh with the rack (104) from the first end of the rack (104) such that the pinion chamfered edge (202A) of the top land (202) of the pinion tooth (108) may be adapted to engage/mesh with the rack chamfered edge (112) of the rack tooth (106) of the first end of the rack (104). The pinion chamfered edge (202A) may be configured to shift the direction of the reaction force that is acting perpendicularly on the pinion chamfered edge (202A) of the top land (202) of the pinion tooth (108), by certain degree away from the radial direction of the pinion (102). This deviation in reaction force prevents jamming or improper meshing of the pinion tooth (108) of the pinion (102) with the rack tooth (106) of the first end (104A) of the rack (104). Due to small contact area between the pinion chamfered edge (202A) of the top land (202) of the pinion tooth (108) and the rack chamfered edge (112) of the rack tooth (106) of the rack (104), locking between the pinion tooth (108) and the rack tooth (106) is prevented, while meshing the pinion (102) with the rack (104). Various configurational iterations of the rack and pinion drive apparatus (100) of the present disclosure are possible, for example, if the pinion (102) engages with the rack (104) from the second end (104B) of the rack (104) then the set of rack teeth of the number of rack teeth (106) that are arranged on the second end (104B) of the rack (104) exhibits rack chamfered edge (112).

In some embodiments, the minimum distance between two consecutive or adjacent normal rack teeth (106) may lie between from about 10 mm to about 11 mm.

In some embodiments, the minimum distance between a normal rack tooth (106) and the rack tooth (106) provided with the rack chamfered edge may lie between from about 11 mm to about 13 mm.

In some embodiments, the chamfer is on the face and flank surface of the pinon teeth (108), which cut the tooth along face width.

In some embodiments, the chamfer is on one side of the pinion teeth (108).

In some embodiments, the pinion (102) moves in direction perpendicular to axis of rotation of pinion (102), and parallel to the pitch line of rack teeth (106) for engaging with rack (104).

In some embodiments, the width of rack tooth (106) is same for each tooth on rack (104) and chamfer is provided on face and flank surface of rack tooth (106) along face width.

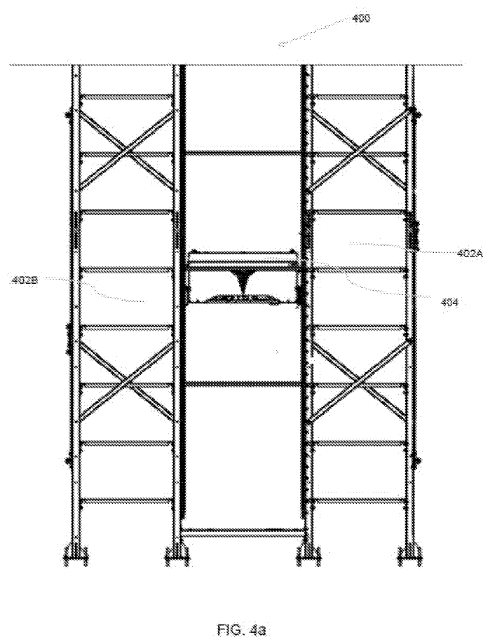

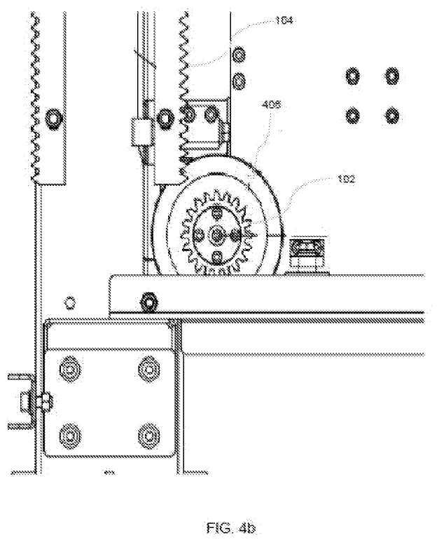

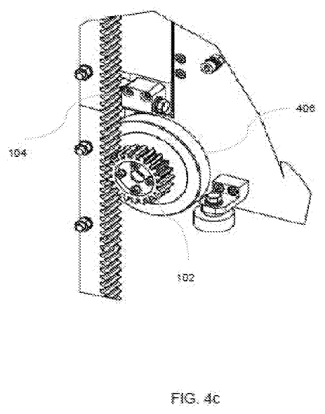

FIG. 4a illustrates a front view of a storage facility (400) of a warehouse. FIG. 4b illustrates a front view of the rack and pinion drive apparatus (100) in the storage facility (400) of the warehouse. FIG. 4c illustrates an isometric view of the rack and pinion drive apparatus (100) in the storage facility (400) of the warehouse. The storage facility (400) includes a number of shelf (402A, 402B) (hereinafter referred to and designated as “the shelf (402)”) and a robot (404). The robot includes a number of wheel (406) {hereinafter referred to and designated as “robot wheel (406)”}.

The shelf (402) of the storage facility (400) includes the rack (104) having a first end (104A) and a second end (104B) (as previously shown in FIG. 1) such that the length of the rack (104) extends from the first end (104A) to the second end (104B). The rack (104) further includes a number of rack teeth (106) (hereinafter individually referred to and designated as “the rack tooth (106)”) such that the number of rack teeth (106) are arranged from the first end (104A) to the second end (104B) of the rack (104). The number of rack teeth (106) further includes a set of rack teeth of the number of rack teeth (106) comprising a rack chamfered edge (112) (as previously shown in FIG. 3). The robot (404) of storage facility (400) includes the robot wheel (406), which is operatively connected to the pinion (102). The pinion (102) includes the number of pinion teeth (108) (hereinafter referred to and designated as “the pinion tooth (108)”) (as previously shown in FIG. 1). The pinion teeth of the plurality of pinion teeth (108) comprises a top land (202) and a bottom land (204) (as previously shown in FIG. 2b). The top land (202) of the pinion tooth (108) may exhibit a pinion chamfered edge (202A) (as previously shown in FIG. 2b). Further, the robot (406) of the storage facility (400) is operatively coupled to the rack (104) of the shelf (402) through the pinion (102).

In operation, the pinion (102) of the robot wheel (406) may be configured to mesh with the rack (104) of the shelf (402) from the first end of the rack (104) such that the pinion chamfered edge (202A) of the top land (202) of the pinion tooth (108) may be adapted to engage/mesh with the rack chamfered edge (112) of the rack tooth (106) of the first end of the rack (104). The pinion chamfered edge (202A) may be configured to shift the direction of the reaction force that is acting perpendicularly on the pinion chamfered edge (202A) of the top land (202) of the pinion tooth (108), by certain degree away from the radial direction of the pinion (102). This deviation in reaction force prevents jamming or improper meshing of the pinion tooth (108) of the pinion (102) with the rack tooth (106) of the first end (104A) of the rack (104). Due to small contact area between the pinion chamfered edge (202A) of the top land (202) of the pinion tooth (108) and the rack chamfered edge (112) of the rack tooth (106) of the rack (104), locking between the pinion tooth (108) and the rack tooth (106) is prevented, while meshing the pinion (102) of robot (404) with the rack (104) of shelf (402).

In some embodiments, the pinion (102) of the robot (404) engages with the rack (104) of the shelf (402) from the second end (104B) of the rack (104) then the set of rack teeth of the number of rack teeth (106) that are arranged on the second end (104B) of the rack (104) exhibits rack chamfered edge (112).

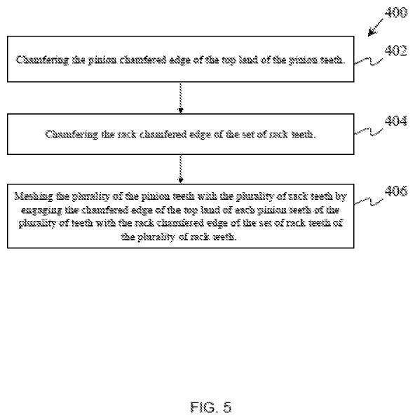

FIG. 5 illustrates a flow chart of a method (400) for meshing the pinion (102) with the rack (104), according to another embodiment herein.

At step (402), chamfering the pinion chamfered edge (202A) of the top land (202) of the pinion tooth (108) such that the pinion chamfered edge (202A) may be adapted to engage/mesh with the rack chamfered edge (112) of the rack tooth (106) of the first end of the rack (104).

At step (404), chamfering the rack chamfered edge (112) of a set of rack teeth of a number of rack teeth (106) such that the rack chamfered edge (112) may be adapted to engage/mesh with the pinion chamfered edge (202A) of the pinion tooth (108).

At step (406), meshing (406) the number of the pinion teeth (108) with the number of rack teeth (106) by engaging the chamfered edge (202A) of the top land (202) of each pinion teeth of the number of teeth (108) with the rack chamfered edge (112) of the set of rack teeth of the number of rack teeth (106).

The method (400) further includes shifting of the direction of reaction force from the radial direction of the pinion (102) such that the degree of shift of the direction of the reaction force lie between from 35° to about 45° from the radial direction of the pinion (102).

Certain advantages of the rack and pinion drive apparatus (100) of the present disclosure are listed hereinbelow:
No noise, while meshing the pinion (102) with the rack (104).
There is no locking or jamming, while the pinion tooth (108) engages or meshes with the set of rack teeth of the number of rack teeth (106) of the rack (104).

We claim:

1. A rack and pinion drive apparatus (100) comprising:
a pinion (102) having a plurality of pinion teeth (108) in a manner that each pinion teeth of the plurality of pinion teeth (108) comprise a top land (202) and a bottom land (204);
a rack (104) having a plurality of rack teeth (106) in a manner that a set of rack teeth of the plurality of rack teeth (106) comprise a rack chamfered edge (112);
wherein the top land (202) of each pinion teeth of the plurality of pinion teeth (108) comprises a pinion chamfered edge (202A) in a manner that the pinion chamfered edge (202A) is configured to engage with the rack chamfered edge (112) of the set of rack teeth of the plurality of rack teeth (106) to facilitate meshing of the plurality of pinion teeth (108) with the plurality of rack teeth (106);
wherein a chamfer angle of the pinion chamfered edge (202A) of the top land (202) of the pinon tooth (108) lie between from about 5 degrees (5°) to about 45 degrees (45)°.

2. The rack and pinion drive apparatus (100) as claimed in claim 1, wherein height of the plurality of pinion teeth (108) lie between from about 6 milli-meter (6 mm) to about 8 mm.

3. The rack and pinion drive apparatus (100) as claimed in claim 1, wherein the pinion chamfered edge (202A) of the top land (202) of the pinion tooth (108) is configured to shift the direction of reaction force from the radial direction of the pinion (102) such that the degree of shift of the direction of the reaction force lie between from 35° to about 45° from the radial direction of the pinion (102).

4. The rack and pinion drive apparatus (100) as claimed in claim 1, wherein the width of the plurality of pinion teeth (108) lie between from about 4.5 mm to about 5 mm.

5. A storage facility (400) of warehouse comprising:
a robot (404) having a robot wheel (406) operatively coupled to a pinion (102 configured to rotate on the rack (104);
the pinion (102) having a plurality of pinion teeth (108) in a manner that each pinion teeth of the plurality of pinion teeth (108) comprises a top land (202) and a bottom land (204);
a plurality of shelf (402) having a rack (104);
the rack (104) having a plurality of rack teeth (106) in a manner that a set of rack teeth of the plurality of rack teeth (106) comprising a rack chamfered edge (112);
wherein the top land (202) of each pinion teeth of the plurality of pinion teeth (108) comprises a pinion chamfered edge (202A) in a manner such that the pinion chamfered edge (202A) is configured to engage with the rack chamfered edge (112) of the set of rack teeth of the plurality of rack teeth (106) to facilitate meshing of the plurality of pinion teeth (108) with the plurality of rack teeth (106).

6. The storage facility (400) as claimed in claim 5, wherein the pinion chamfered edge (202A) of the top land (202) of the pinion tooth (108) is configured to shift the direction of reaction force from the radial direction of the pinion (102) such that the degree of shift of the direction of the reaction force lie between from 35° to about 45° from the radial direction of the pinion (102).

7. A method (400) for meshing a pinion (102) with a rack (104), the method (400) comprising:
chamfering (402) a pinion chamfered edge (202A) of a top land (202) of each pinion teeth of a plurality of pinion teeth (108);
chamfering (404) a rack chamfered edge (112) of a set of rack teeth of a plurality of rack teeth (106); and
meshing (406) the plurality of the pinion teeth (108) with the plurality of rack teeth (106) by engaging the chamfered edge (202A) of the top land (202) of each pinion teeth of the plurality of teeth (108) with the rack chamfered edge (112) of the set of rack teeth of the plurality of rack teeth (106).

8. The method (400) as claimed in claim 7, further comprising:
shifting the direction of reaction force from the radial direction of the pinion (102) such that the degree of shift of the direction of the reaction force lie between from 35° to about 45° from the radial direction of the pinion (102).

9. The method (400) as claimed in claim 7, wherein the pinion (102) is configured to mesh with the rack (104) from either of a first end (402) or a second end (404) of the rack (104) such that the pinion (102) rolls in direction perpendicular to the axis of rotation of the pinion (102) and parallel to the pitch line of rack teeth while meshing with the rack (104).
